(19) United States
(12) Patent Application Publication
(10) Pub. No.: US 2001/0037380 A1
(43) Pub. Date: Nov. 1, 2001

(54) Web site hosting model

(75) Inventors: John R. Wall, Redmond, WA (US); Marvin A. Mall, Duvall, WA (US); David N. Brim, Custer, WA (US); Joseph C. Younger, Lynden, WA (US); Frank Schmitt, Bellingham, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: CommunityIQ.com

(21) Appl. No.: 09/823,097

(22) Filed: Mar. 29, 2001

Related U.S. Application Data
(60) Provisional application No. 60/199,310, filed on Apr. 24, 2000.

(51) Int. Cl. G06F 15/16

(52) U.S. Cl. 709/219; 709/227

(57) ABSTRACT

A computer based business model and method for operating, and maintaining a web site capable of hosting a web site for individuals, families, non-profit organizations and small businesses on the World Wide Web is disclosed. This method includes a means of receiving a request to host a web site for a user, identifying that user by a unique identifier such as a phone number or student identification number, determining specific information about the unique user by accessing a pre-configured database containing such information, and then creating code for a set of web documents that correspond to the unique information that was identified in the pre-configured database. The hosting web site also provides hosting capabilities which allow an administrator of the hosted web site the ability to manipulate and configure the code for the set of web documents with numerous features and attributes Additionally, the hosting web site provides for notification to the administrator when particular events have occurred, such as a customer purchase or a low inventory item. This notification can be accomplished by a change in web document appearance, e-mail or voice mail.

### CROSS-REFERENCE TO RELATED APPLICATION

This application is a patent application in reference to prior U.S. provisional patent application Ser. No. 60/199,310, filed Apr. 24, 2000, priority from the filing date of which is hereby claimed under 35 U.S.C. § 119.

### FIELD OF THE INVENTION

This invention relates to a business model and method for operating and maintaining a web site capable of hosting a web site for individuals, families, non-profit organizations, small businesses and others that lack expertise and resources to establish their own web presence.

### BACKGROUND OF THE INVENTION

Traditionally, a company has been limited geographically and monetarily by the number of customers that it could effectively reach. In order to establish a global presence, and significant incremental amount of money was necessary to establish advertising, sales, distribution in any given area. With the advent and acceptance of the world wide web and the internet, the cost for a business to reach even the most remote customers has been substantially reduced. Through a company web site and e-commerce, a business can promote, compare, and sell its merchandise to customers who access its web site from any networked computer having access to the world wide web. Thus even the smallest of companies could establish a global presence on the internet by establishing, maintaining and expanding a company web site. However, cost and technological animosity has prevented the very smallest of companies from attempting to establish a web presence. The cost of equipment and maintenance of the networking computers necessary can still be preventative to a small business. Additionally, the technical expertise is often lacking to effectively maintain and expand a company's web site once established.

### SUMMARY OF THE INVENTION

This invention provides a new method for establishing, maintaining, and updating a web site that will provide persons such as individuals, families, non-profit organizations and small businesses with the opportunity to establish an effective web presence without the initial cost of computer equipment or the technical knowledge necessary.

The method detailed herein involves receiving a request by a user to create a set of web documents to be hosted at a web site hosting computer system. When a request is made, the user is identified using a unique identifier such as a phone number or student ID number and then checked against an existing database of information. If located within the database, corresponding information is determined and then used to create a set of web documents that the user will further personalize and configure. The web site hosting computer also provides web site hosting functions to the user such as a means for customers to purchase goods and services.

Additionally, the web site hosting computer provides a method of web site event monitoring assistance. In the course of hosting a set of web documents for a user, the user can configure various events such as receiving an e-mail or an order from a customer. The web site hosting computer will determine when an event has occurred will notify the uniquely identified user of the event's occurrence. In one embodiment, this notification is accomplished by changing an image color or appearance within the set of web documents. In another embodiment, this notification is accomplished by sending an e-mail to the uniquely identified user. In yet another embodiment, this notification is accomplished by sending a voicemail to the uniquely identifies user.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a depiction of an interconnected network that is used to represent the Internet.

FIG. 2 is a graphical depiction of the layout of the internetworked computers that make up the web hosting site of the present invention.

FIG. 3 is a flow chart that describes the process by which a small business owner would establish an e-commerce site through the web hosting service.

FIG. 4 depicts an exemplary home page of a small business that has created an e-commerce site using the web hosting site of the present invention.

FIG. 5 depicts the log-in page for the small business site created.

FIG. 6 depicts an exemplary home page of a small business that has created an e-commerce site using the web hosting site of the present invention once the administrator has logged in.

FIG. 7 depicts a typical Administrator Home page.

FIG. 8 depicts a flowchart of the various administrative capabilities available to the administrator for manipulation and configuration of the web site.

FIG. 9 depicts the flowchart for the administrator page monitor program.

FIG. 10 depicts the flowchart for the web site monitor program.

### DETAILED DESCRIPTION OF THE PREFERRED EMBODIMENT

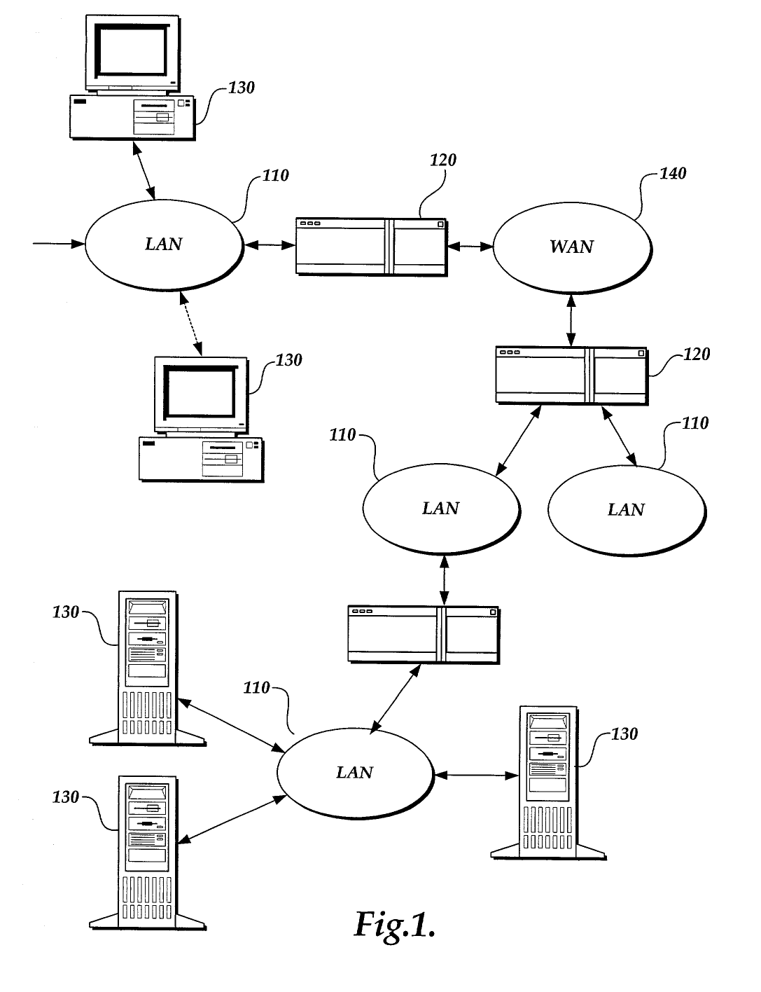

As shown in FIG. 1, the Internet 100 is a collection of local area networks, or LANs 110, wide area networks, or WANs 140, remote computers 130 and routers 120 that use the Transmission Control Protocol/Internet Protocol (TCP/IP) to communicate with each other. The World Wide Web, or WWW, on the other hand, is a vast collection of interconnected, electronically stored information located on servers 130 connected throughout the Internet 100. Many consumers and companies are now buying and selling goods, services, and access to their premium content over the Internet using the WWW.

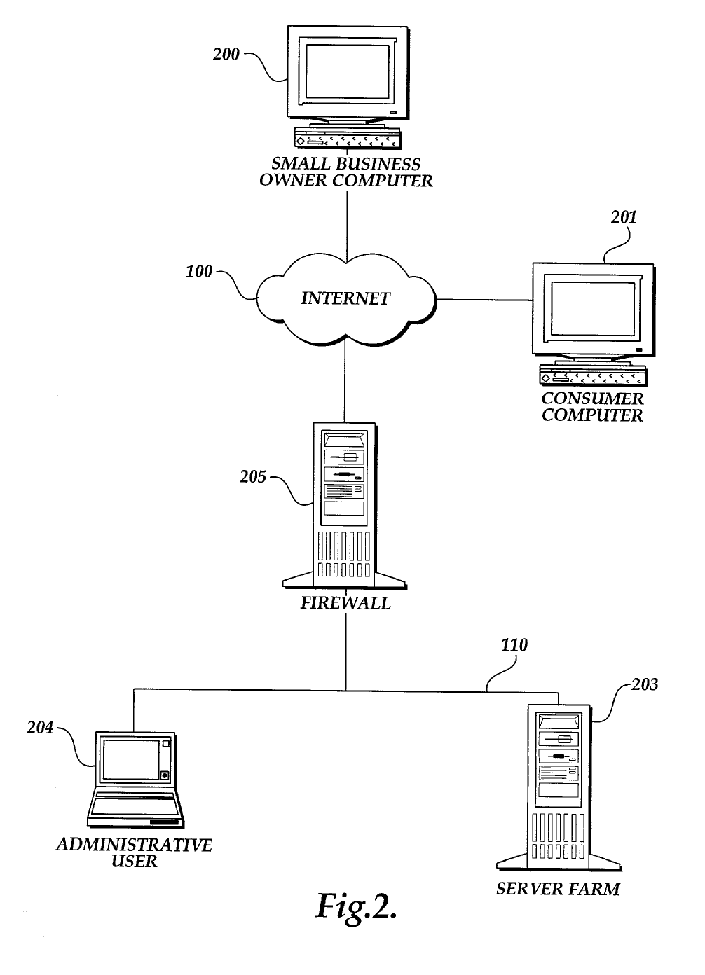

In accordance with the present invention, an individual, family, non-profit organization, or small business owner can access a web site and establish a presence on the WWW using the method detailed herein. More specifically, as shown in FIG. 2, the customer, in this case small business owner, can access, maintain, and configure the hosted web site, which is stored in the server farm 203 from his/her personal computer 200. Similarly, a consumer can purchases goods, services, and/or premium content from the web site 203, by accessing it via the internet 100 from his/her personal computer 201. Due to the high number of web sites being hosted, a server farm 203 is necessary to handle the volume. Additionally, the host web site administrator has capability of access and management of all hosted web sites via an administrator computer 204. Finally, those of ordinary skill in the art will recognize that while only one small business owner computer 200, and one consumer computer 201 are depicted in FIG. 2, numerous small business owner computers and consumer computers equipped with a multitude of hardware and software components may be connected to the Internet 100, and, in turn, connected to the hosted web site. It will also be appreciated that the term “consumer” used herein can be applied to any purchaser of goods, services, and/or content. The interconnection and configuration of the server farm 203, the firewall 205, an administrator computer 204 and the internet 100 are well known in the art and are not detailed here.

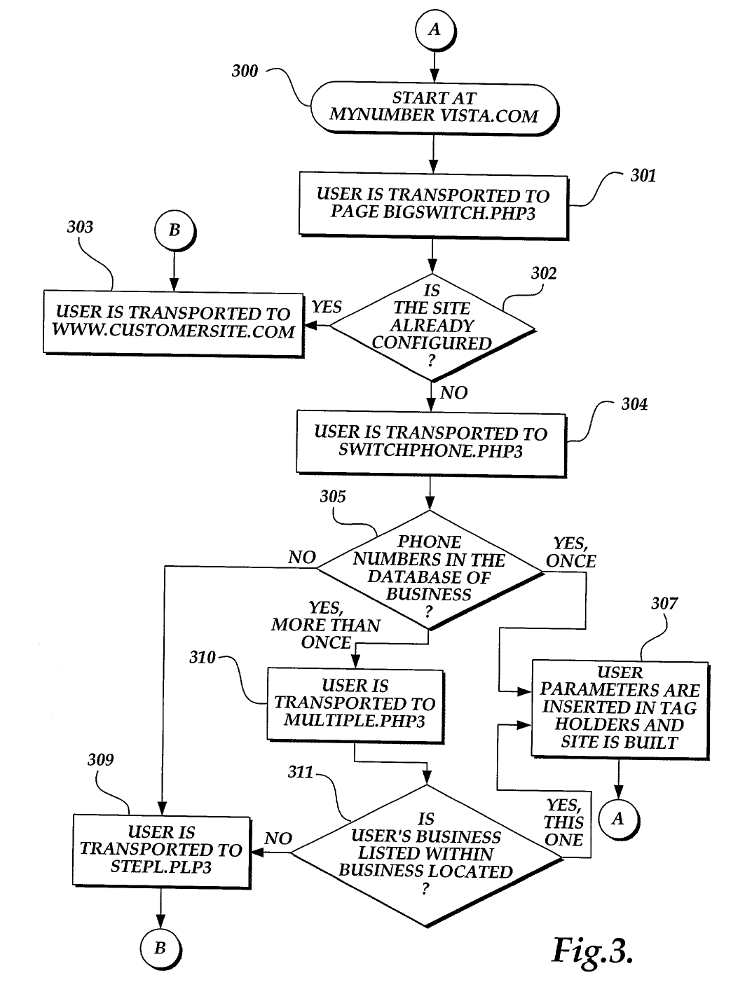

FIG. 3 depicts the flowchart of the method by which a small business owner will establish his/her web site on the WWW using the hosting service of the present invention. This computer based method resides in computer readable instruction on the server farm 203. The web hosting service is accessed via the small business owner's computer 200 and web browsing software residing therein. Using a web browser, the web hosting service is initially accessed by using the small business owner's phone number as a basis for the URL. For example, using 206-555-9000 as a representative phone number, the small business owner would begin by accessing http://www.2065559000.vista.com via the web browsing software residing on the small business owner's computer 200. This initial access of the web hosting web site amounts to a request by a user to create a set of web documents on the host computer system user. The web hosting service maintains a database on the server farm 203 with a multitude of business listings according to phone number. Thus, by using the phone number in the URL, the user can be uniquely identified by checking against the database. Once the user has been uniquely identified, the host computer system determines corresponding information from the database of information to be used in creating a set of web documents. The user's browser is directed to a pre-configured web page that has been initially configured to meet with general specifications of the Standard Industrial Code (SIC) that corresponds to the phone number in the database. For example, the phone number of a law firm would correspond to a SIC identifying it as a law firm, and thus, a collection of web pages will already have been configured in a standard law firm format for this particular phone number.

The web hosting service maintains a pool of several standard sets of web documents per SIC in the server farm that is located at its place of business. These standard sets of web documents are pre-configured with the look and feel of a typical web site of that industry along with typical features found on web sites of that industry. The initial page browsed when any phone number is used in the URL is http://www.vista.com/bigswitch.php3, step 301 of FIG. 3. At this point, this initial web page has coded instructions to use the phone number contained in the base URL to check against a database of web sites that have already been configured. If this phone number is found to be already in the list of already configured web sites, the user's browser is transported to the web site that was previously created. For example, http://www.customersite.vista.com, step 303, where “customersite” is used to represent whatever the small business owner had chosen to call this web site. If the phone number is not found in the list of already configured web sites and a web site has not been configured, i.e. this small business owner has never visited this web site using his or her small business phone number, then the user's browser is transported to a different web page, http://www.vista.com/switchphone.php3, step 304. This page contains coded instructions for causing the initial phone number contained in the original URL to be checked against the large national database of small businesses. By checking against this large national database, the user is identified by the uniqueness of his/her small business phone number.

In step 305, a decision is made as to whether or not the phone number is found once, more than once, or not at all in the database of small businesses. If the phone number is not found, the user's browser is transported to a web page at step 306, http://www.vista.com/admin/phone.php3. In step 308, the user is queried as to whether or not a new business should be created or if a different phone number is to be tried at the initial step 300. If the user chooses to try a different phone number, the user's browser is transported back the page at step 301, http://www.vista.com/bigswitch.php3, and the entire process is repeated with the new phone number to be checked against the database of small businesses. However, if the user chooses to create a new site, the user's browser is transported to a page at step 309, http.//vista.com/admin/step1.php3. At this point, characteristic information is collected from the customer and is used to create a new web site as described in step 307. Corresponding information, such as SIC and business address, for the unique user identified by the small business phone number from the database the large national database.

If at step 305 one phone number is found, then the user's browser is transported to a build web page at step 307, http://www.vista.com/phone/phonicate.php3. The build web page selects one of the pre-configured pages from the pool of ten for the particular SIC code corresponding to the number. Computer readable instructions are then created for a set of web documents using a particular style and particular features that correspond to a SIC that was identified for the unique user. At step 307, the user is prompted to enter parameters such as contact information and email address. This new information is then automatically inserted into tag holders that were programmed into the preconfigured page. Computer readable instructions are then created for a set of web documents that correspond to the contact information that was entered by the unique user. The creation of all computer readable instructions is accomplished by starting two separate threads. One thread runs a stream editor SED script against the directory tree of the site. This script changes all the tags to the appropriate value for the requested site according to the parameters and information entered by the new user. The second thread would cause all database entries for the site to be updated with the information appropriate for the requested site e.g., tag changes. Independently, a second process monitors the pool and replaces a used template sites with a new template site to replace the particular site that was just personalized as the new user site. When both threads complete, http://www.vista.com/bigswitch.php would redirect the browser to the newly personalized site, http://www.customersite.vista.com, step 303. In one particular embodiment, these computer readable instructions are is created in HTML and the features include, but are not limited to, a means of purchasing goods or services, a means for reserving an appointment, a means for posting a message, a means for “chatting” among other users, a means for browsing web documents, and a means for displaying and updating a calendar or events.

The third possibility at step 305, is that the phone number used in the initial URL occurs more than once within the business database. It can be appreciated that often times a small business owner will list his individual phone number under several different business listings SIC codes and types. Thus, the possibility exists that within the small business database, a single phone number will occur more than once. If this is the case, the user is transported to page at step 310, http://www.vista.com/phone/multiple.php3. Each business that matches the phone number in the initial URL is then presented via this page, and the user is queried as to whether or not the specific business that he is trying to configure is within those displayed on the web page. If the user selects the button corresponding to not finding the business listing within those presented, the web site will redirect the user's browser to step 309, http://www.vista.com/admin/phone.php3. However, if the business is located within the list, the user can choose by clicking on the particular business and the web site will redirect the user's browser to step 307 as described above.

The culmination of the entire initial process results in step 303 when a small business owner's web site has been established and is ready for use under pre-built conditions, along with minimal contact information previously entered. At this point, the small business owner is provided with web site hosting functions such as configuration of appearance, personalization of pages and maintenance of the web site. The small business owner's customers can also access this web site by typing in http.//www.“mynumber”.vista.com. The small business owner must establish administrative privileges on this web site by logging in at the initial home page, http://www.customersite.vista.com page, step 303. The actual computer readable instructions of the foregoing method is maintained on the server farm 203 of the web hosting service.

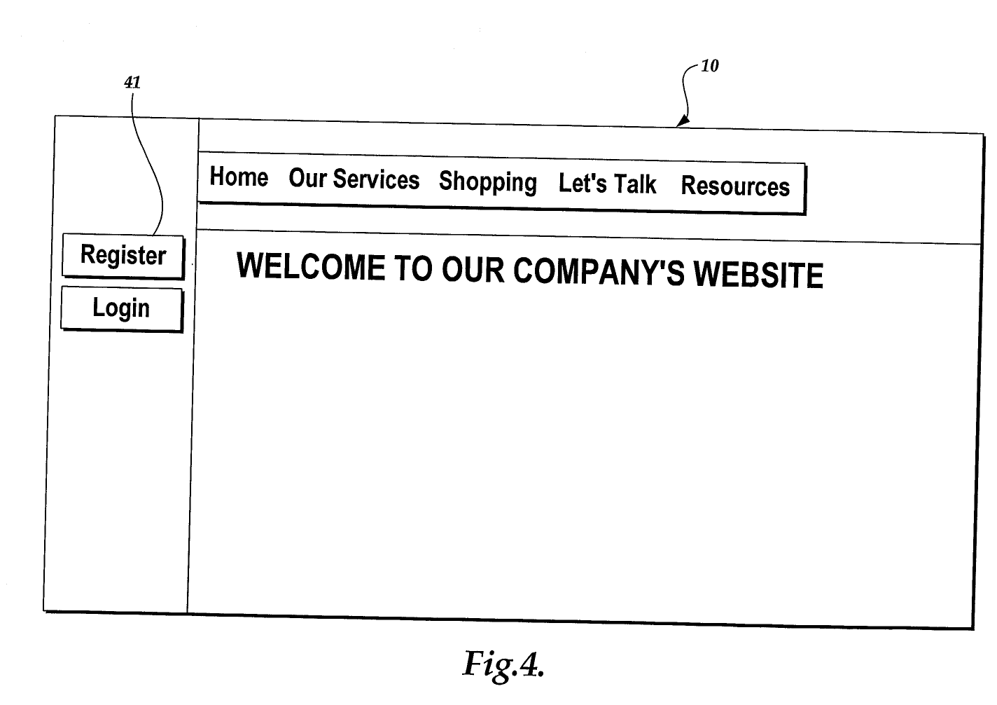

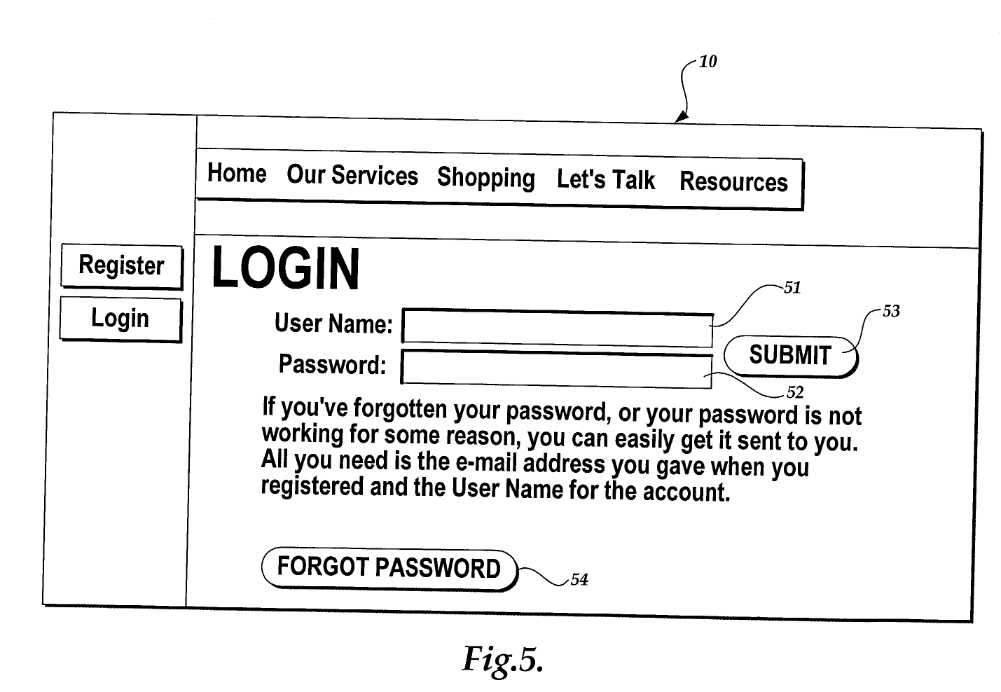

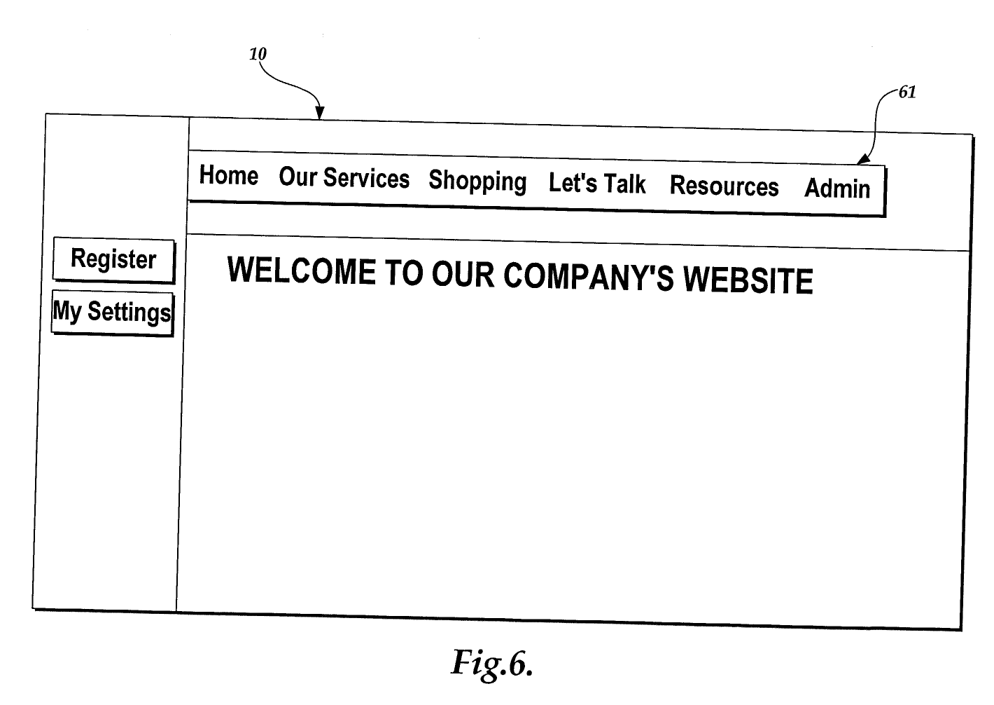

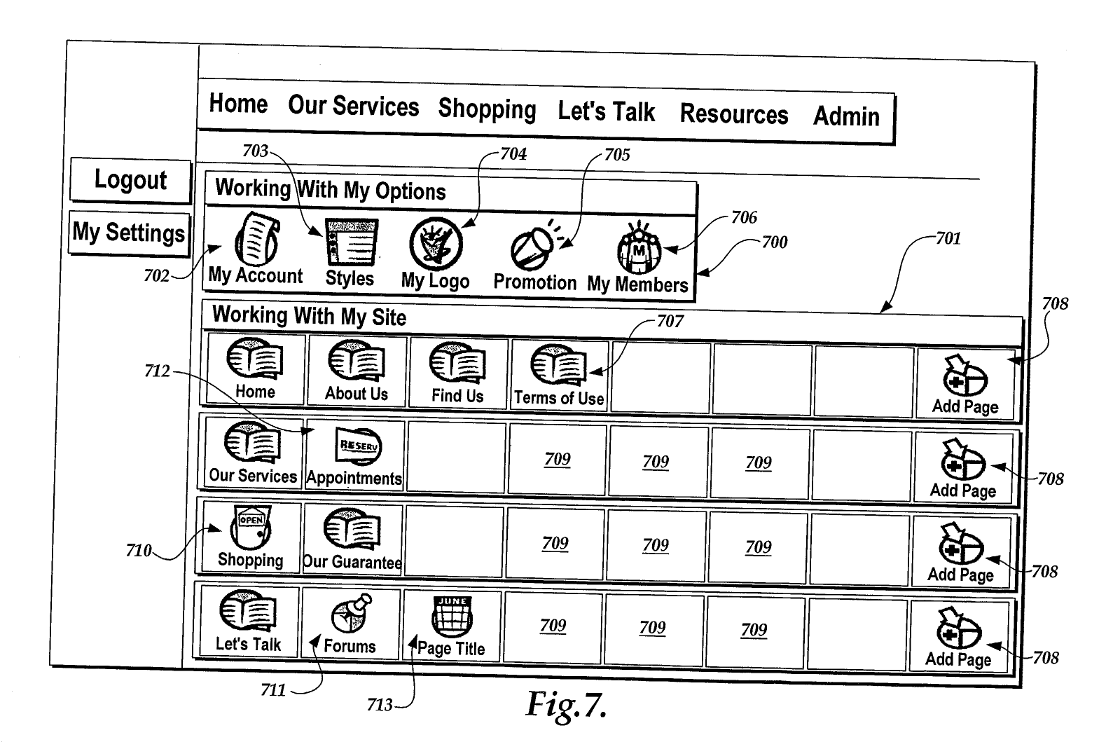

FIG. 4 is a depiction of the home page of an exemplary small business web site created from the present invention. A Login link 41 can be clicked in order for an administrator to log in to the web site in order to configure content. This link will redirect the user's browser to a page depicted in FIG. 5. On this page, two inputs fields are displayed, user name 51 and password 52. The administrator will enter the proper user name and password that were initially requested in the creation phase of the web hosting service. Once this information is typed in, the user clicks the Submit button 53 and if the information is correct, the user's browser will be redirected to the initial home page, http://www.ownersite.vista.com page 303. However, a difference exists as depicted in FIG. 6. When logged in as an administrator, an additional link is available whereby the user can click and be redirected to the Administrator Home Page, FIG. 7. If the user name and password are forgotten during the log in phase, the user may click the Forgot Password button 54 which will cause the web site to prompt user for additional private information prior to revealing the correct password.

FIG. 7 depicts the Administrator Home page. There are two areas of configuration tools that are provided for use at the discretion of the administrator. The My Options section 700 allows an administrator to configure global information about the small business owner's web site, account information, styles of pages, small business owner logo, etc. The other section, My Site 701 allows an administrator to change the individual content of each page within the web site. The administrator may also add additional pages or delete any existing page from the current web site. Each option within these two sections will be described in brief detail below.

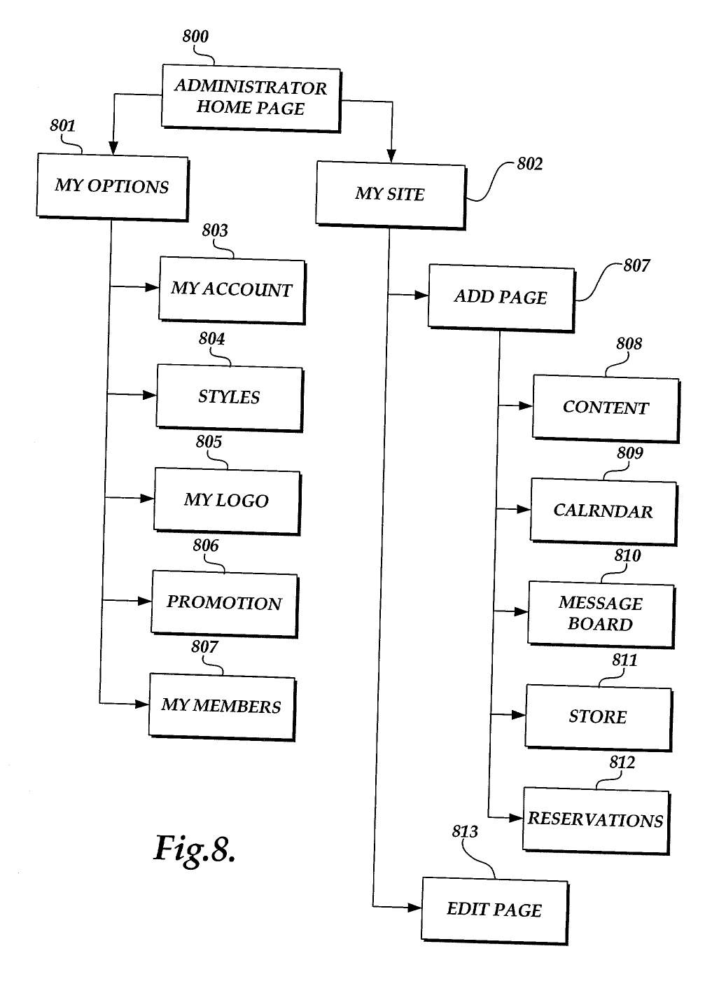

FIG. 8 depicts a high level chart representation of the options available to the administrator for administration of the site. When the site administrator accesses the administration home page 800, two branches of options are at available as alluded to above. Under My Options 801, the administrator may configure the web site account information 803, the style of the web site 804, the web site logo 805, promotional options 806, and member options 807. Under the My Site branch 802, an administrator may make changes to the web site's content. Configuration options include adding a page 807 or editing an existing page 813. If the administrator chooses to add a new page, several kinds of pre-configured pages are available, such as a general content page 808, a calendar page 809, a message boards page 810 a store page 811, and a reservations page 812. This is a non-exhaustive list of available pre-configured web pages available from the web hosting service. The code necessary for implementation of these standard features of a typical web site are well known to those skilled in the art and will not be discussed in any further detail.

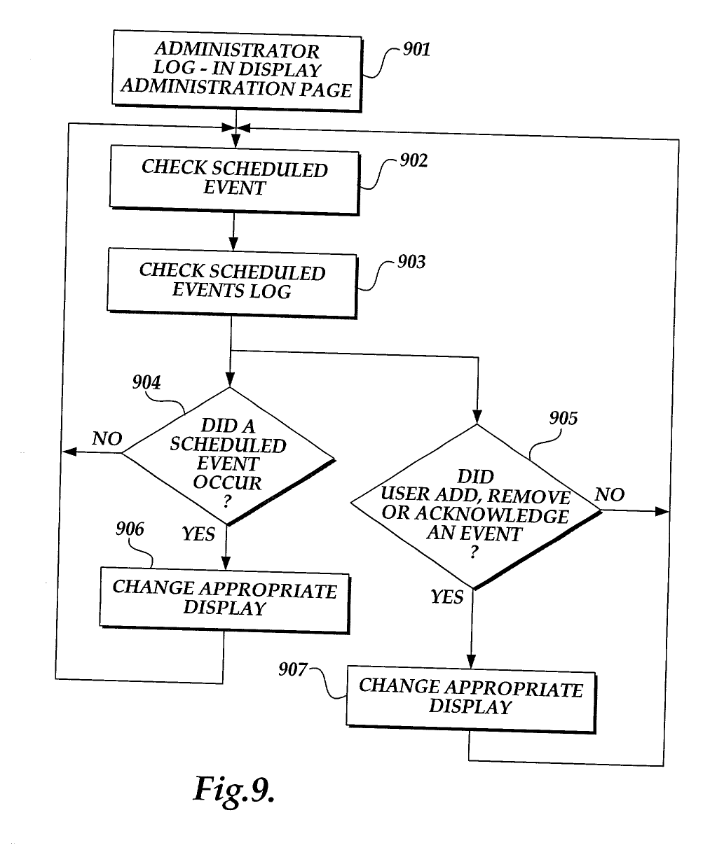

Once the user's web site has been created and established its presence on the WWW, it may accessed and re-configured as the user wishes. When the user initially created the web site, a user administrator name and password are chosen such that a user will have the ability at a later time to return and re-configure various aspects of the set of web documents. The process for accessing the configuration capabilities of the web hosting site is as described previously, whereby the user browses to a password page as depicted in FIG. 5. Once a successful administrator log-in has occurred, the browser is transported to the administrator homepage, as depicted in FIG. 7. By logging in, step 901, an administrator monitor program is initiated and continues to run for the until the administrator logs off. This administrator monitor program, depicted in flowchart form in FIG. 9, has coded instructions for identifying the occurrence of a specified event and recording this event into an event log. For each event that the administrator establishes as an event to monitor, the coded instructions will check a particular scheduled event, step 902 and its corresponding status in the events log, step 903 and determine whether or not it has occurred in step 904. If an event has occurred, step 904, or if the administrator has acknowledged that an event has occurred, step 905, the administrator home page display is changed appropriately in steps 906 and 907. Typical events that may occur include but are not limited to, a customer order for goods or services, receiving e-mail from a customer, an inventory shortage due to an order placed by a customer of the web site, and passage of a specific time and date. While logged in, the administrator can monitor the administrator home page for web site activity. Coded instructions will cause a physical change in appearance or color of particular items within the administrator home page when a particular event identified previously occurs. In one particular embodiment, these coded instructions are accomplished using HTML.

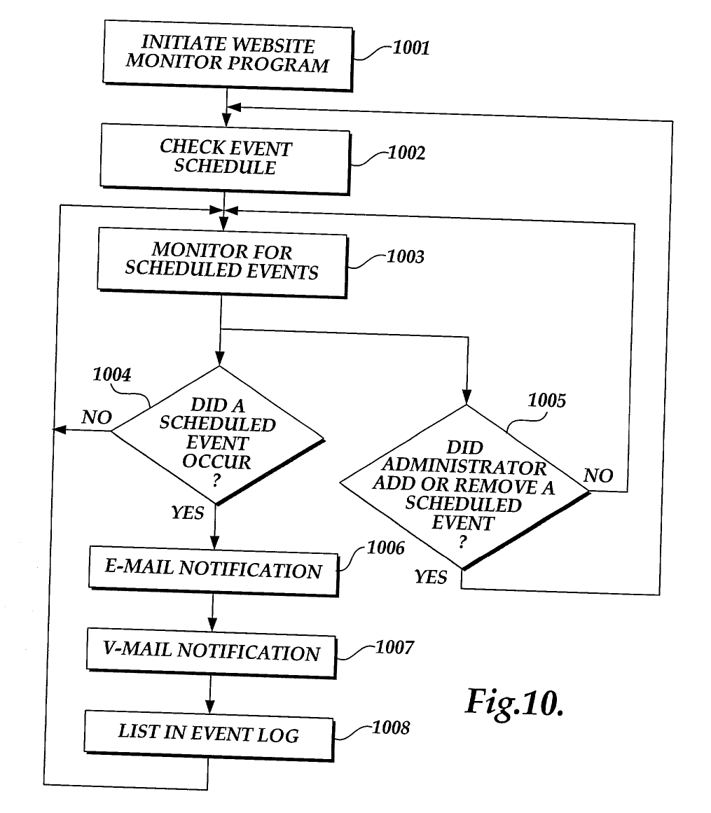

In further embodiments of the present invention, a computer implemented method for notifying an administrator of the occurrence of an event is presented. FIG. 10 depicts a method for monitoring and updating an event schedule for the web site. When a web site is established, a web site monitor program is initiated in step 1001. A schedule of events is maintained and can be modified by the web site administrator. Upon each iteration of the web site monitor program, the event schedule is checked, step 1002, and then each event in the event schedule is monitored in step 1003. If a particular event has occurred, step 1004, then an e-mail notification may be sent to a specified e-mail address, step 1006 and/or a voice mail may be sent to a specified voice mail message system, step 1007 Additionally, the occurrence of an event will cause the event to be recorded in an event log, step 1008. If the administrator has removed the event form the event schedule, step 1005, then the program loop re-initializes by checking the event schedule and repeats step 1002. In one particular embodiment, the foregoing computer implemented method is realized using HTML code.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A computer based method for creating and using computer readable instructions for a set of web documents on a web site, the method comprising:
receiving a request by a user to create a set of web documents on a host computer system;
identifying said user based upon a unique identifier associated with the user;
determining corresponding information for the unique user identified from a database of information using said unique identifier;
creating computer readable instructions for a set of web documents using said corresponding information to be executed on the host computer system; and
providing web site hosting functions from the host computer system to the interconnected client computer to the unique user for using said set of web documents.

2. The method of claim 1, wherein the request to create a set of web documents is received via an internetworked set of computers.

3. The method of claim 1, wherein said unique identifier is based upon a phone number.

4. The method of claim 1, wherein said unique identifier is based upon a student identification number.

5. The method of claim 1, wherein the computer readable instructions for each said set of web documents is created in HTML.

6. The method of claim 1, wherein the computer readable instructions provide the unique user a means of choosing at least one feature for the set of web documents.

7. The method of claim 6, wherein the at least one feature is a means of purchasing services or merchandise.

8. The method of claim 6, wherein the at least one feature is a means of reserving an appointment.

9. The method of claim 6, wherein the at least one feature is a means of posting a message to a message board.

10. The method of claim 6, wherein the at least one feature is a means of using the internet to chat with other users of a web site.

11. The method of claim 6, wherein the at least one feature is a means of browsing content of web documents on the web site.

12. The method of claim 6, wherein the at least one feature is a means of displaying and updating a calendar of events.

13. The method of claim 6, wherein the at least one feature is a predetermined style and layout for the set of web documents.

14. A computer based method for providing web site event monitoring assistance to an administrator of a hosted web site, the method comprising:
hosting a set of web documents on the World Wide Web for an administrator,
identifying an administrator for the set of hosted web documents,
providing computer readable instructions that identify when an event has occurred that the set of web documents are capable of producing,
determining that an event has occurred that requires the attention of the administrator of the set of web documents, and
notifying the administrator of the event.

15. The method of claim 14, further comprising identifying the administrator of the set of web documents by a unique username and password.

16. The method of claim 14, wherein notification to the administrator is by means of electronic mail.

17. The method of claim 14, wherein notification to the administrator is by means of voice mail.

18. The method of claim 14, wherein notification to the administrator is by means of changing the color of an image within the set of web documents.

19. The method of claim 14, wherein notification to the administrator is by means of changing the appearance of an image within the set of web documents.

20. The method of claim 14, wherein the event may be an order for service or merchandise by a customer of the web site.

21. The method of claim 14, wherein the event is receiving e-mail from a customer of the web site.

22. The method of claim 14, wherein the event is an inventory shortage because of an order placed by a customer of the web site.

23. The method of claim 14, wherein the event is the passage of time without changing the content of a web document.

24. The method of claim 14, wherein the event is the passage of time beyond a specified time and date.

25. The method of claim 14, wherein the computer readable instructions for implementing the method are in HTML and reside at a host computer system.
